(19) United States
(12) Patent Application Publication
(10) Pub. No.: US 2017/0263388 A1
(43) Pub. Date: Sep. 14, 2017

(54) PROCESS FOR LITHIUM LOADED ELECTRODE MANUFACTURING FOR LITHIUM-ION CAPACITORS

(71) Applicant: GENERAL CAPACITOR, LLC, Tallahassee, FL (US)

(72) Inventor: Wanjun Cao, Tallahassee, FL (US)

(73) Assignee: GENERAL CAPACITOR, LLC, Tallahassee, FL (US)

(21) Appl. No.: 15/457,097

(22) Filed: Mar. 13, 2017

Related U.S. Application Data
(60) Provisional application No. 62/308,058, filed on Mar. 14, 2016.

(51) Int. Cl. H01G 11/86; H01G 11/30

(52) U.S. Cl. CPC H01G 11/86; H01G 11/30

(57) ABSTRACT

The present invention is directed to a Process for Lithium Loaded Electrode Manufacturing for Lithium-Ion Capacitors, wherein there is provided a system of manufacture of electrodes using a lithium foil, and in particular, to the process of manufacturing lithium loaded negative electrodes for lithium-ion capacitors and the like using lithium foil, lithium strips and/or lithium films, employing a roll-to-roll manufacturing process wherein there is no drying time and no heat required to be applied to the laminator rolls, and wherein a lithium loaded negative electrode is manufactured using lithium foil strips in a roll-to-roll process, may include a top lithium strip and a bottom lithium strip on the negative electrode generated by the roll-to-roll process.

### FIELD OF THE INVENTION

The present invention relates to the manufacture of electrodes, and in particular, to the process of manufacturing lithium loaded negative electrodes for lithium-ion capacitors and the like using lithium foil or lithium film, and a roll-to-roll manufacturing process.

### BACKGROUND OF THE INVENTION

The manufacture of lithium loaded electrodes involves attachment of a relatively pliable layer to a relatively rigid layer. Negative electrodes used in lithium-ion capacitors and the like, constitute one class of electrodes manufactured in this fashion.

Electrodes are widely used in many devices that store electrical energy, including primary (non-rechargeable) battery cells, secondary battery cells, fuel cells, and capacitors. Because of various competing performance criteria that need to be considered when designing electrodes, many electrodes are constructed using two or even more constituent materials. One application where such composite electrodes are often used is construction of double layer capacitors, also known as electrochemical capacitors, supercapacitors, and ultracapacitors.

Double layer capacitors employ, as their energy storage elements, electrodes immersed in an electrolytic solution (electrolyte). Typically, a porous separator impregnated with the electrolyte ensures that the electrodes do not come in contact with each other. A double layer of charges is formed at each interface between the solid electrodes and the electrolyte. Double layer capacitors owe their descriptive name to these layers.

In comparison to conventional capacitors, double layer capacitors have high capacitance in relation to their volume and weight. There are two main reasons for this volumetric and weight efficiency. First, the width of the charge separation layers is very small, on the order of nanometers. Second, the electrodes can be made from a porous material, having very large effective area per unit volume, i.e., very large normalized effective surface area. Because capacitance is directly proportional to the electrode area, and inversely proportional to the width of the charge separation layer, the combined effect of the narrow charge separation layer and large surface area results in capacitance that is very high in comparison to that of conventional capacitors. High capacitance enables double layer capacitors to receive, store, and release large supplies of electrical energy.

Another important performance parameter of a capacitor is its internal resistance, also known as equivalent series resistance (ESR). Frequency response of a capacitor depends on the characteristic time constant of the capacitor, which is essentially a product of the capacitance and the internal resistance, or RC. To put it differently, internal resistance limits both charge and discharge rates of a capacitor, because the resistance limits the current that flows into or out of the capacitor. Maximizing the charge and discharge rates is important in many applications. In hybrid automotive applications, for example, a capacitor used as the energy storage element powering a vehicle's engine has to be able to provide high instantaneous power during acceleration, and to receive power produced by regenerative braking.

High internal resistance may create heat during both charge and discharge cycles. Heat causes mechanical stresses and speeds up various chemical reactions, thereby accelerating capacitor aging. Moreover, the energy converted into heat is lost, decreasing the efficiency of the capacitor. It is therefore desirable to reduce internal resistance of capacitors.

Active materials used for electrode construction—activated carbon, for example—usually have rather limited specific conductance. Thus, large contact area may be desired to minimize the contact resistance between the electrode and its terminal. The active material may also be too brittle or otherwise unsuitable for directly connecting to terminals. Additionally, the material may have relatively low tensile strength, needing mechanical support in some applications. For these reasons, electrodes typically incorporate current collectors.

A current collector is typically a sheet of conductive material on which the active electrode material is deposited. Aluminum foil is commonly used as the current collector material of an electrode. In one electrode fabrication process, a solvent based electrode film is produced, and then attached to a thin aluminum foil using a wet solvent based adhesive or binder layer. To improve the quality of the interfacial bond between the film of active electrode material and the current collector, the combination of the film and the current collector is processed in a pressure laminator, for example, a calendar or another nip. Pressure lamination increases the bonding forces between the film and the current collector, and reduces the equivalent series resistance. After laminating the combination of solvent based electrode film, wet adhesive binder, and current collector are subsequently dried to remove any liquid solvent, lubricants, or impurities.

As has already been mentioned, high capacitances of double layer capacitors result, to a great extent, from the high normalized effective surface area of the active electrode layers. Porosity of the active electrode layer film plays an important role in increasing the effective surface area. Generally, porosity on a small-scale level is unchanged when the active electrode film is densified through compaction, for example, through calendaring or processing in another kind of high-pressure nip. Because compacting reduces the film's volume while keeping pore surfaces relatively unchanged, the normalized effective surface area is increased. Furthermore, compacting tends to decrease the equivalent series resistance, and possibly also improves structural integrity of the film. For these reasons, current solvent based active electrode films are often compacted before they are attached to current collectors.

The material of a typical active electrode film is compressible and malleable. When the film is processed in a calendar, alone, or onto a wet adhesive binder layer, it tends not only to density through compaction in the direction of pressure application, but also to deform, elongating and widening in the plane transverse to this direction. This is problematic for two reasons. First, densification is reduced, potentially requiring multiple compaction/densification steps. Second, the film may need to be trimmed because of spreading, i.e., because of the elongation and widening. Trimming becomes necessary, for example, when the film spreads beyond the current collector surface, or when the film spreads to the areas of the current collector that need to be connected to other components, such as terminals or other electrodes. The additional compacting and trimming steps increase processing costs and time, and are best reduced or avoided altogether. These problems are not necessarily limited to electrode fabrication, but may be relevant when densifying and laminating other compressible materials.

Numerous innovations for the Process for Electrode Manufacturing have been provided in the prior art that are described as follows. Even though these innovations may be suitable for the specific individual purposes to which they address, they differ from the present design as hereinafter contrasted. The following is a summary of those prior art patents most relevant to this application at hand, as well as a description outlining the difference between the features of the Process for Electrode Manufacturing and the prior art.

U.S. Pat. No. 7,935,155 issued to Mitchell, et al. describes a method of manufacturing an electrode product where a compressible and deformable layer is densified and laminated to a layer of a material that is relatively resistant to stretching. The densification and bonding take place in a single step. A method as used in fabrication of electrodes, for example, electrodes for double layer capacitors, a deformable and compressible active electrode film is manufactured from activated carbon, conductive carbon, and a polymer. The electrode film may be bonded directly to a collector. Alternatively, a collector may be coated with a wet adhesive layer. The adhesive layer is subsequently dried onto the foil. The dried adhesive and foil combination may be manufactured as a product for later sale or use, and may be stored as such on a storage roll or other storage device. The active electrode film is overlaid on the metal foil, and processed in a laminating device, such as a calendar. Lamination both densities the active electrode film and bonds the film to the metal foil. Spreading of the active electrode film in the plane parallel to the plane of the metal foil is reduced or eliminated during lamination, because of the adhesion between the film and the foil.

This patent describes a process which is typical and conventional, but does not include the use of lithium foil strips to be used in the manufacture of lithium loaded negative electrodes for a lithium-ion capacitor cell by lamination with a carbon electrode material such as graphite, soft or hard carbon or the like.

US pending Patent Application Publication No. 2014/0146440 of Gadkaree et al. discloses a lithium-ion capacitor which may include a cathode, an anode, a separator disposed between the cathode and the anode, a lithium composite material, and an electrolyte solution. The cathode and anode may be non-porous. The lithium composite material comprises a core of lithium metal and a coating of a complex lithium salt that encapsulates the core. In use, the complex lithium salt may dissolve into and constitute a portion of the electrolyte solution.

Wherein this pending patent application publication describes a lithium ion capacitor and production of methods for making same, it does not include the use of lithium foil strips to be used in the manufacture of lithium loaded negative electrodes for a lithium-ion capacitor cell by lamination with a carbon electrode material such as graphite, soft or hard carbon or the like.

US pending Patent Application Publication No. 2011/0300290 of Kim et al. teaches and describes a device for fabricating an electrode by a roll-to-roll process and a method for fabricating an electrode. The device for fabricating an electrode includes an unwinding roll and a winding roll traveling an electrode material; a film forming roll disposed between the unwinding roll and the winding roll allowing the electrode material to travel along a cylindrical surface of the film forming roll and having a cooling unit cooling the electrode material, and an evaporation unit receiving a lithium source and mounted for the received lithium source to form a thin film in the electrode material positioned on the film forming roll. Thereby, the lithium is deposited in a vacuum atmosphere such that the process is simple and the deposition rate and the deposition uniformity of lithium can be improved.

While this pending patent application publication describes a device for fabricating an electrode by a roll-to-roll process, and a method for fabricating such an electrode, it does not include the use of lithium foil strips to be used in the manufacture of lithium loaded negative electrodes for a lithium-ion capacitor cell by lamination with a carbon electrode material such as graphite, soft or hard carbon or the like.

US pending Patent Application Publication No. 2014/0178594 of Kobayashi et al, discloses and teaches a time for doping an electrode material on an electrode sheet with a lithium ion can be reduced. The electrode manufacturing apparatus includes a processing chamber to and from which the electrode sheet is loaded and unloaded; a rare gas supply unit configured to introduce a rare gas into the processing chamber; an exhaust device configured to exhaust an inside of the processing chamber to a certain vacuum level; and a lithium thermal spraying unit configured to dope a carbon material C with the lithium ion by forming a lithium thin film on the carbon material of the electrode sheet W loaded into the processing chamber while melting and spraying lithium-containing powder.

Whereas this pending patent application publication describes an electrode manufacturing apparatus for lithium-ion capacitor and electrode manufacturing and a method therefor, it does not include the use of lithium foil strips to be used in the manufacture of lithium loaded negative electrodes for a lithium-ion capacitor cell by lamination with a carbon electrode material such as graphite, soft or hard carbon or the like.

Therefore, none of these previous efforts provides the benefits attendant with the present inventive Process for Electrode Manufacturing. The present design achieves its intended purposes, objects and advantages over the prior art through a new, useful and unobvious combination of method steps and component elements, as is described in greater detail below.

In this respect, before explaining at least one embodiment of the Process for Electrode Manufacturing in detail it is to be understood that the process is not limited in its application to the details of construction and to the arrangement of the components set forth in the following description or illustrated in the drawings. The Process for Electrode Manufacturing is capable of other embodiments and of being practiced and carried out in various ways. in addition, it is to be understood that the phraseology and terminology employed herein are for the purpose of description and should not be regarded as limiting.

### SUMMARY OF THE INVENTION

The principle advantage of the Process for Electrode Manufacturing is the use of pure Li foil strips.

Another advantage of the Process for Electrode Manufacturing is the lack of heat and adhesive drying time required.

Another advantage of the Process for Electrode Manufacturing is that the resulting lithium loaded negative electrodes are significantly enhanced in their performance characteristics.

Another advantage of the Process for Electrode Manufacturing is that the density is maximized as the lithium foil is pure elemental metal and at its highest possible density.

Another advantage of the Process for Electrode Manufacturing is that quality control over the manufacturing process is greatly simplified and relates to tension control of the rollers, as well as detecting and removing portions of the electrode which do not meet manufacturing standards.

Another advantage of the Process for Electrode Manufacturing is that the use of lithium foil strips does not require any powdering or spraying steps, both of which increase time and expense of manufacturing electrodes and this method has no safety issues.

Yet another advantage of the Process for Electrode Manufacturing is that the present method provides a much more economical method of manufacturing lithium loaded negative electrodes for use in lithium-ion capacitors and the like.

In summary, there is provided a system of lithium loaded electrode manufacturing for lithium-ion capacitors wherein a lithium loaded negative electrode is manufactured using lithium foil strips in a roll-to-roll process.

Further in summary, the method for lithium loaded electrode manufacturing for lithium-ion capacitors is provided, wherein a lithium loaded negative electrode is manufactured using lithium foil stripes in a roll-to-roll process, comprising the steps of: (a) the manufacturing process should be done in a temperature and humidity controlled clean and dry room; (b) providing the negative electrode sheet and the top Li foil strip and bottom Li foil strip; (c) feed roll insertion of the bottom Li film strip through tension control rolls and the lamination rolls; (d) feed roll and the insertion of the negative electrode sheet through the tension control rolls and into the lamination rolls; (e) feed roll insertion of the top Li film strip through the tension rolls and into the lamination rolls; and (f) exertion of pressure on the lamination rolls and the extension of the laminated Li loaded negative electrode sheet through the tension control rolls and on to the take up roll to be completed and ready for use in Li-ion capacitors; wherein there is no adhesive drying time and no heat required on the lamination rolls, the pressure may be adjusted as required to press the top Li foil strip and bottom Li foil strip into the negative electrode sheet and the gap between the top Li foil strip, and bottom Li foil strip may be adjusted according to the to the laminated Li loaded negative electrode sheet requirements.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the Process for Electrode Manufacturing. Further, since numerous modifications and changes will readily occur to those skilled in the art, it is not desired to limit the design to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the Process for Electrode Manufacturing and together with the description, serve to explain the principles of this application.

FIG. 1 is a block diagram of the steps for the Process of Electrode Manufacturing.

FIG. 2 is a diagram of the roll with the negative electrode sheet, the top and bottom rolls of the Li foil sheets, the tension rolls, the lamination rolls, the secondary tension rolls and the take up roll.

FIG. 3 is an illustration of the combination of rolls used in the manufacturing process of a laminated Li loaded negative electrode sheet with a single set of top and bottom Li foil strips used to determine the correct roll location and the proper gap between the top and bottom Li foil strips.

FIG. 4 is a side view of a section of the Li foil strips illustrating the thickness requirement.

FIG. 5 is a top plan view of a segment of the laminated product illustrating a top strip of Li foil above the negative electrode sheet with the bottom strip of Li foil below, indicating the gap tolerances between the foil segments.

FIG. 6 is a top plan view of the negative electrode sheet on its feed roll adjacent to the rollers of the op and bottom Li foil strips and back around between the lamination rollers and out the other side. For illustration purposes the tension rollers have been omitted and the segments have been broken to indicate that varying numbers of top and bottom Li foil strip combinations can be manufactured in this process.

FIG. 7 is an illustration of a combination of rolls used in the manufacturing process of a lithium loaded negative electrode sheet between seven sets of top and bottom Li foil strips in a mass production operation. The number of top and bottom Li foil strips and the width of the negative electrode sheet may vary depending upon the quantity required.

FIG. 8 is a cross section through segment of the negative electrode sheet between the top and bottom Li foil strips.

For a fuller understanding of the nature and advantages of the Process for Electrode Manufacturing, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

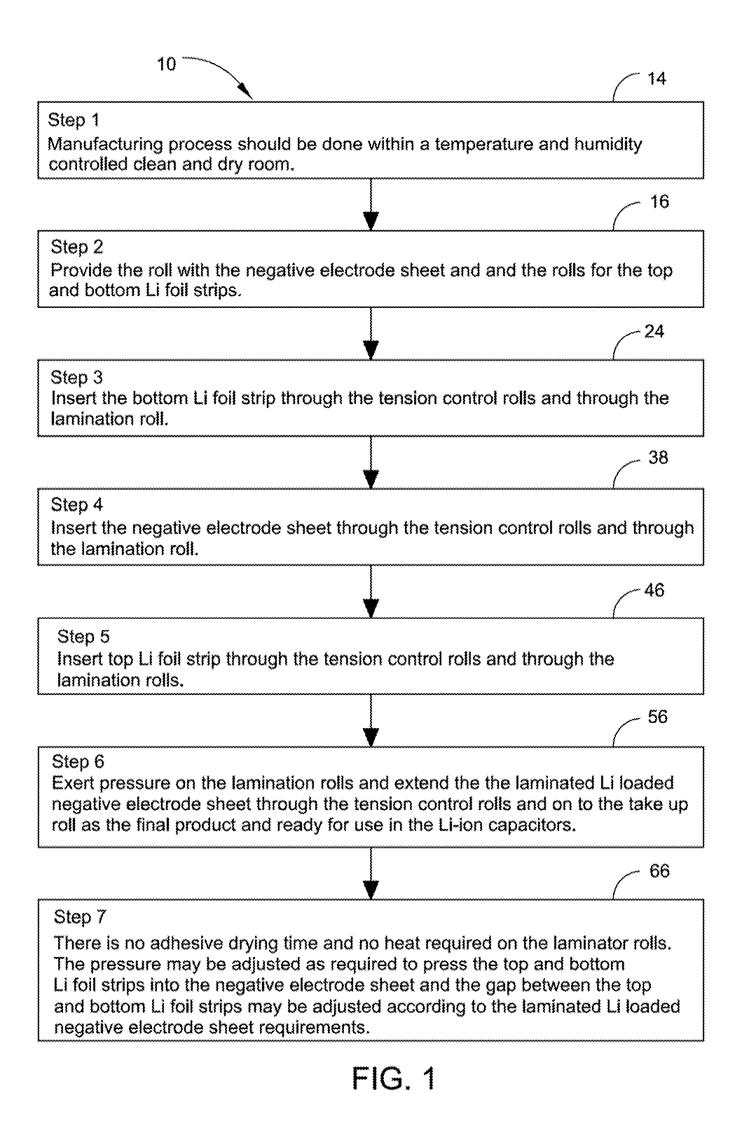

Referring now to the drawings, wherein similar parts of the Process for Electrode Manufacturing 10 are identified by like reference numerals, there is seen in FIG. 1 a block diagram that describes the steps for the Process for Electrode Manufacturing 10 wherein said process includes, but is not limited to, the following seven steps:

Step one 14 describes that the manufacturing process should be done in a temperature and humidity controlled clean and dry room.

Step two 16 describes providing the negative electrode sheet 18 and the top Li foil strip 20 and bottom Li foil strip 22. The terms “lithium foil strips,” or “Li foil” and “lithium films” or “Li film” will be used interchangeably throughout this specification detailed description.

Step three 24 describes the feed roll 26 insertion of the bottom Li film strip 22 through tension control rolls 28, 30 and 32 and the lamination rolls 34 and 36.

Step four 38 describes the feed roll 40 and the insertion of the negative electrode sheet 18 through the tension control rolls 42 and 44 and into the lamination rolls 34 and 36.

Step five 46 describes the feed roll 48 and the insertion of the top Li film strip 20 through the tension rolls 50, 52 and 54 and into the lamination rolls 34 and 36.

Step six 56 explains the exertion of pressure on the lamination rolls 34 and 36 and the extension of the laminated Li loaded negative electrode sheet 58 through the tension control rolls 60 and 62 and on to the take up roll 64 to be ready for the use in the Li-ion capacitors.

Step seven 66 explains that there is no adhesive drying time and no heat required on the lamination rolls 34 and 36. The pressure may be adjusted as required to press the top Li foil strip 20 and bottom Li foil strip 22 into the negative electrode sheet 18 and the gap 68 between the top Li foil strip 20 and bottom Li foil strip 22 may be adjusted according to the to the laminated Li loaded negative electrode sheet 58 requirements.

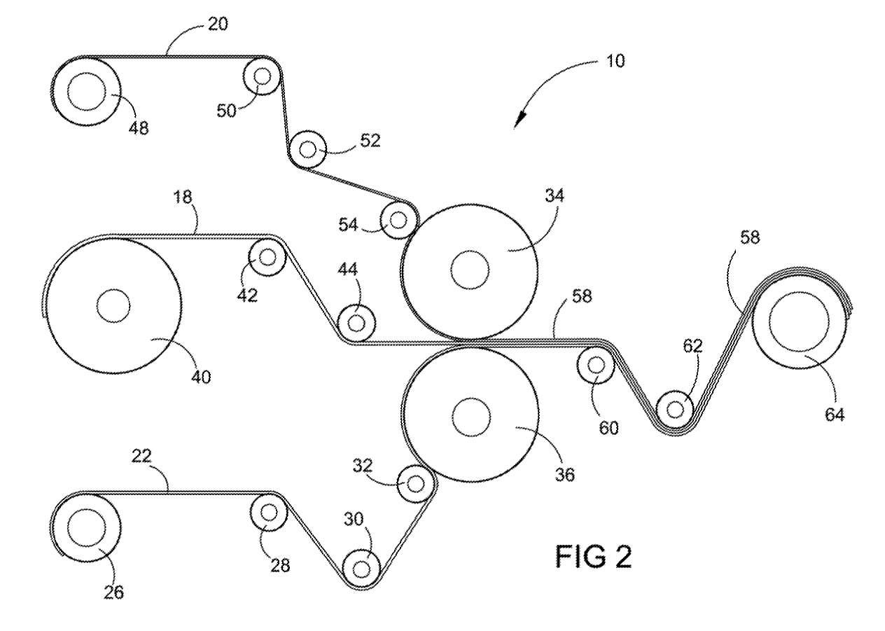

FIG. 2 is a diagram of the Process for Electrode Manufacturing with the top Li foil strip 20 material feeding into the three tension rolls 50, 52 and 54 and into the lamination rolls 34 and 36.

The feed roll 40 with the negative electrode sheet 18 fed through the tension control rolls 42 and 44 and into the lamination rolls 34 and 36.

The feed roll 26 with the bottom Li film strip 22 fed through tension control rolls 28, 30 and 32 and the lamination rolls 34 and 36.

The pressure is applied with the lamination rolls 34 and 36 and the laminated Li loaded negative electrode sheet 58 passes through the tension control rolls 60 and 62 and on the take up roll 64 to complete the manufacture process and generate a lithium loaded negative electrode ready for use in Li-ion capacitors. There is no adhesive drying time and no heat required on the lamination rolls, the pressure may be adjusted to a pressure range of 40 to 400 kg/cm² as required to press the top Li foil strip and bottom Li foil strip into the negative electrode sheet and the gap between the top Li foil strip, and bottom Li foil strip may be adjusted according to the laminated lithium loaded negative electrode sheet requirements. The resulting width range of the manufactured negative electrode is about 2 mm to about 300 mm. The thickness range of the negative electrode before being loaded with lithium is about 20 μm to about 400 μm. The negative electrode materials used in manufacturing include graphite, hard carbon, soft carbon and Li₄Ti₁₅O₁₂. The width range of the lithium strips and lithium films is about 1 mm to about 100 mm. The thickness range of the lithium strips/films is about 5 μm to about 150 μm. The number range of the lithium foil strips on one side of negative electrode is from 2 to about 10. The gap distance between all lithium strips on one side of negative electrode is about 0.5 mm to about 50 mm. Furthermore, the present method of lithium loaded electrode manufacturing for lithium-ion capacitors wherein a lithium loaded negative electrode is manufactured using lithium foil strips in a roll-to-roll process, according to the instant invention, may include a top lithium fill and a bottom lithium film within the manufactured negative electrode. When both a top and bottom lithium strip or film is present, the gap distance between said top lithium strip and said bottom lithium strip is about 0 mm to about 50 mm.

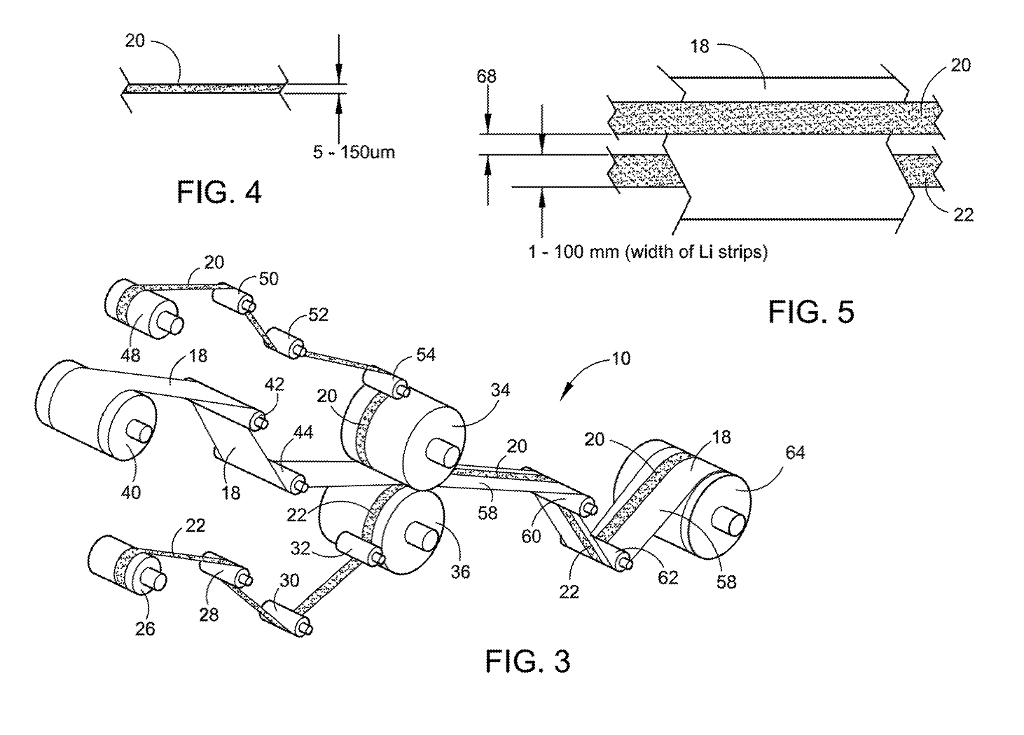

FIG. 3 is an illustration of the combination of rolls used in the manufacturing process of a laminated Li loaded negative electrode sheet 58 with a single set of top and bottom Li foil strips 20 and 22 used to determine the correct roll location and the proper gap 68 (as shown in FIG. 5) between the top and bottom Li foil strips 20 and 22.

FIG. 4 is a side view of a section of the pure Li foil strips 20 and 22 illustrating the thickness requirements of about 5 μm to about 150 μm thick with a preferred thickness of about a range of 20 μm to 50 μm. The total thickness range of the negative electrode 18 before being loaded with lithium is about 20 μm to about 400 μm.

FIG. 5 is a top plan view of a segment of the laminated product illustrating a top strip of Li foil 20 above the negative electrode sheet 18 with the bottom strip of Li foil 22 below, indicating the proper gap 68 tolerances between the foil segments as a range of approximately 0 mm to 50 mm, and the width of the top and bottom Li foil strips 20 and 22 has a range of approximately 1 mm to 100 mm. The total width range of the negative electrode is about 2 mm to about 300 mm. The thickness range of said lithium films is about 5 μm to about 150 μm. The number range of said lithium foil strips on one side of negative electrode is from about 2 strips to about 10 strips. The gap distance between all lithium strips on one side of negative electrode is about 0.5 mm to about 50 mm. As shown, lithium strips may be placed on the top surface and the bottom surface of the negative electrode during manufacture, according to the present invention. Therefore, the present system of lithium loaded electrode manufacturing for lithium-ion capacitors wherein a lithium loaded negative electrode is manufactured using lithium foil strips in a roll-to-roll process, may include a top lithium strip and a bottom lithium strip, as required. When both top and bottom lithium strips are present, the gap distance between the top lithium strip and the bottom lithium strip is about 0 mm to about 50 mm.

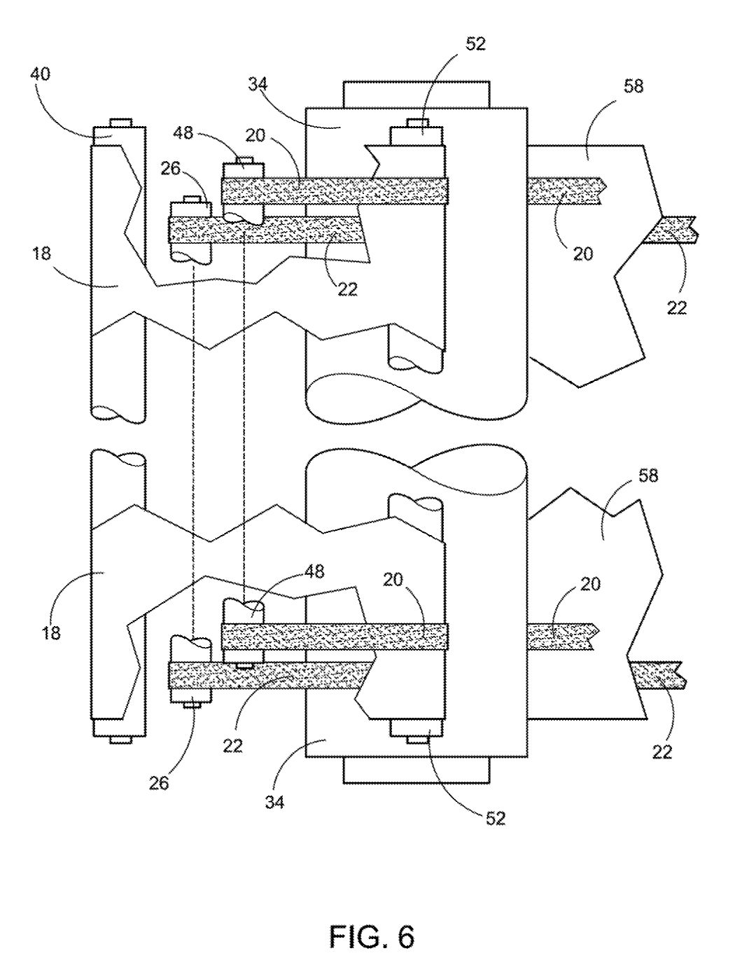

FIG. 6 is a top plan view of the negative electrode sheet 18 on its feed roll adjacent to the rollers of the top and bottom Li foil strips 20 and 22 and back around between the lamination rollers 34 and 36 and out the other side. For illustration purposes the tension rollers have been omitted and the segments have been broken to indicate that varying numbers of top and bottom Li foil strip 20 and 22 combinations can be manufactured in this process. The total width range of the lithium foil strips are about 1 mm to about 100 mm.

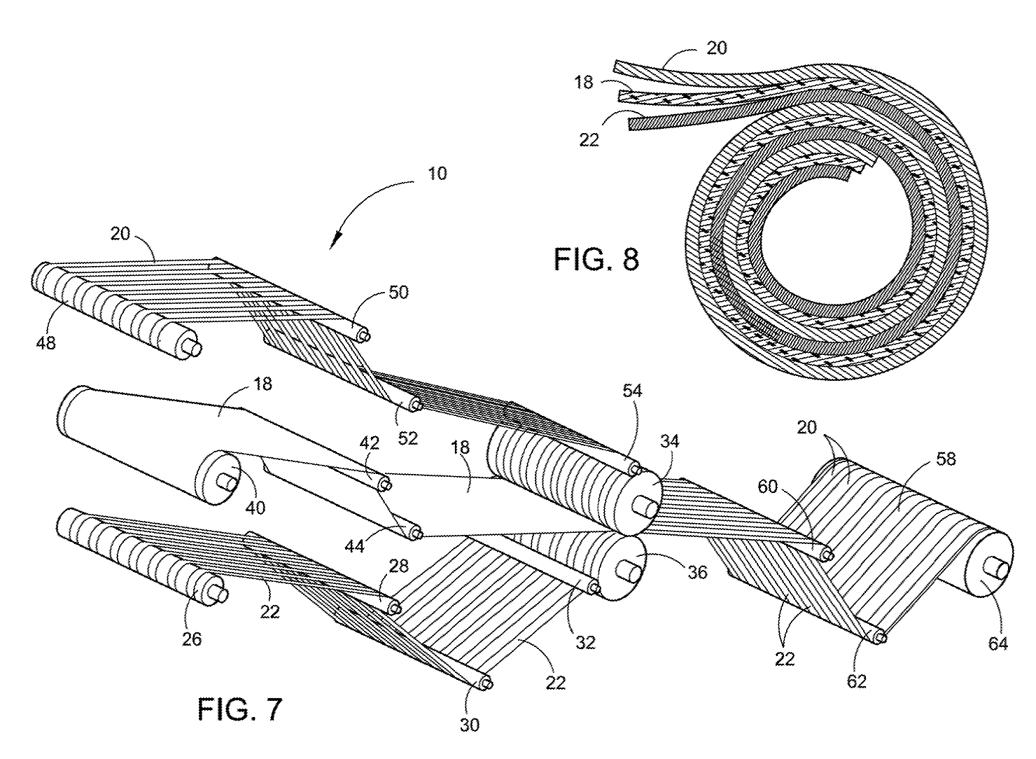

FIG. 7 is an illustration of a combination of rolls used in the manufacturing process of a laminated Li loaded negative electrode sheet 58 between seven sets of top and bottom Li foils strips 20 and 22 in a mass production operation. The number of top and bottom Li foils strips 20 and 22 and the width of the negative electrode sheet 18 may vary depending upon the quantity required. The total width range of the negative electrode is about 2 mm to about 300 mm.

FIG. 8 is a cross section through segment of the negative electrode sheet 18 between the top and bottom Li foil strips 20 and 22. The negative electrode materials include graphite, hard carbon, soft carbon and Li₄T₁₅O₁₂.

The Process for Lithium Loaded Electrode Manufacturing for Lithium-Ion Capacitors 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Process for Lithium Loaded Electrode Manufacturing for Lithium-Ion Capacitors 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A system of lithium loaded electrode manufacturing for lithium-ion capacitors wherein a lithium loaded negative electrode is manufactured using lithium foil strips in a roll-to-roll process.

2. The system of lithium loaded electrode manufacturing for lithium-ion capacitors wherein a lithium loaded negative electrode is manufactured using lithium foil strips in a roll-to-roll process, according to claim 1, wherein the width range of said negative electrode is about 2 mm to about 300 mm.

3. The system of lithium loaded electrode manufacturing for lithium-ion capacitors wherein a lithium loaded negative electrode is manufactured using lithium foil strips in a roll-to-roll process, according to claim 1, wherein the thickness range of said negative electrode before being loaded with lithium is about 20 μm to about 400 μm.

4. The system of lithium loaded electrode manufacturing for lithium-ion capacitors wherein a lithium loaded negative electrode is manufactured using lithium foil strips in a roll-to-roll process, according to claim 1, wherein the said negative electrode material includes graphite, hard carbon, soft carbon and Li₄T₁₅O₁₂.

5. The system of lithium loaded electrode manufacturing for lithium-ion capacitors wherein a lithium loaded negative electrode is manufactured using lithium foil strips in a roll-to-roll process, according to claim 1, wherein the width range of said lithium foil strips are about 1 mm to about 100 mm.

6. The system of lithium loaded electrode manufacturing for lithium-ion capacitors wherein a lithium loaded negative electrode is manufactured using lithium foil strips in a roll-to-roll process, according to claim 1, wherein the thickness range of said lithium films is about 5 μm to about 150 μm.

7. The system of lithium loaded electrode manufacturing for lithium-ion capacitors wherein a lithium loaded negative electrode is manufactured using lithium foil strips in a roll-to-roll process, according to claim 1, wherein the number range of said lithium foil strips on one side of negative electrode is from 2 to about 10.

8. The system of lithium loaded electrode manufacturing for lithium-ion capacitors wherein a lithium loaded negative electrode is manufactured using lithium foil strips in a roll-to-roll process, according to claim 7, wherein the gap distance between all lithium strips on one side of negative electrode is about 0.5 mm to about 50 mm.

9. The system of lithium loaded electrode manufacturing for lithium-ion capacitors wherein a lithium loaded negative electrode is manufactured using lithium foil strips in a roll-to-roll process, according to claim 1, includes a top lithium strip and a bottom lithium strip.

10. The system of lithium loaded electrode manufacturing for lithium-ion capacitors wherein a lithium loaded negative electrode is manufactured using lithium foil strips in a roll-to-roll process, according to claim 9, further includes a top lithium strip and a bottom lithium strip, wherein the gap distance between said top lithium strip and said bottom lithium strip is about 0 mm to about 50 mm.

11. A method for lithium loaded electrode manufacturing for lithium-ion capacitors wherein a lithium negative electrode is manufactured using lithium foil strips in a roll-to-roll process, comprising the steps of:
(a) the manufacturing process should be done in a temperature and humidity controlled clean and dry room;
(b) providing the negative electrode sheet and the top Li foil strip and bottom Li foil strip;
(c) feed insertion of the bottom Li film strip through tension controlled rolls and the lamination rolls;
(d) feed roll and the insertion of the negative electrode sheet through the tension control rolls and into the lamination rolls;
(e) feed roll insertion of the top Li film strip through the tension rolls and into the lamination rolls; and
(f) exertion of pressure on the lamination rolls and the extension of the laminated Li loaded negative electrode sheet through the tension control rolls and on to the take up roll to be completed and ready for use in Li-ion capacitors;
wherein there is no adhesive drying time and no heat required on the lamination rolls, the pressure may be adjusted to a pressure range of 40 to 400 kg/cm² as required to press the top Li foil strip and bottom Li foil strip into the negative electrode sheet and the gap between the top Li foil strip, and bottom Li foil strip may be adjusted according to the to the laminated Li loaded negative electrode sheet requirements.

12. The method of lithium loaded electrode manufacturing for lithium-ion capacitors wherein a lithium loaded negative electrode is manufactured using lithium foil strips in a roll-to-roll process, according to claim 11, wherein the width range of said negative electrode is about 2 mm to about 300 mm.

13. The method of lithium loaded electrode manufacturing for lithium-ion capacitors wherein a lithium loaded negative electrode is manufactured using lithium foil strips in a roll-to-roll process, according to claim 11, wherein the thickness range of said negative electrode before being loaded with lithium is about 20 μm to about 400 μm.

14. The method of lithium loaded electrode manufacturing for lithium-ion capacitors wherein a lithium loaded negative electrode is manufactured using lithium foil strips in a roll-to-roll process, according to claim 11, wherein the said negative electrode material includes graphite, hard carbon, soft carbon and Li₄T₁₅O₁₂.

15. The method of lithium loaded electrode manufacturing for lithium-ion capacitors wherein a lithium loaded negative electrode is manufactured using lithium foil strips in a roll-to-roll process, according to claim 11, wherein the width range of said lithium films is about 1 mm to about 100 mm.

16. The method of lithium loaded electrode manufacturing for lithium-ion capacitors wherein a lithium loaded negative electrode is manufactured using lithium foil strips in a roll-to-roll process, according to claim 11, wherein the thickness range of said lithium films is about 5 μm to about 150 μm.

17. The method of lithium loaded electrode manufacturing for lithium-ion capacitors wherein a lithium loaded negative electrode is manufactured using lithium foil strips in a roll-to-roll process, according to claim 11, wherein the number range of said lithium foil strips on one side of negative electrode is from 2 to about 10.

18. The method of lithium loaded electrode manufacturing for lithium-ion capacitors wherein a lithium loaded negative electrode is manufactured using lithium foil strips in a roll-to-roll process, according to claim 17, wherein the gap distance between all lithium strips on one side of negative electrode is about 0.5 mm to about 50 mm.

19. The method of lithium loaded electrode manufacturing for lithium-ion capacitors wherein a lithium loaded negative electrode is manufactured using lithium foil strips in a roll-to-roll process, according to claim 11, includes a top lithium film and a bottom lithium film.

20. The method of lithium loaded electrode manufacturing for lithium-ion capacitors wherein a lithium loaded negative electrode is manufactured using lithium foil strips in a roll-to-roll process, according to claim 19, further includes a top lithium film and a bottom lithium film, wherein the gap distance between said top lithium strip and said bottom lithium strip is about 0 mm to about 50 mm.
